(19) United States
(12) Patent Application Publication
(10) Pub. No.: US 2014/0188382 A1
(43) Pub. Date: Jul. 3, 2014

(54) VEHICLE ROUTE PLANNING METHOD AND APPARATUS

(71) Applicant: NEC (China) Co., Ltd., Beijing (CN)

(72) Inventors: ZHENG PAN, BEIJING (CN); MAN LI, BEIJING (CN); WEISONG HU, BEIJING (CN); XIAOWEI LIU, BEIJING (CN)

(73) Assignee: NEC (China) Co., Ltd., Beijing (CN)

(21) Appl. No.: 13/950,479

(22) Filed: Jul. 25, 2013

(30) Foreign Application Priority Data
Dec. 28, 2012 (CN) CN201210587548.1

(51) Int. Cl. G01C 21/34

(52) U.S. Cl. CPC G01C 21/3469
USPC 701/410

(57) ABSTRACT

A vehicle route planning method and apparatus include: acquiring a current location, a destination location, and an amount of remaining energy of a vehicle; if energy needs to be supplemented for the vehicle to travel from the current location to the destination location, determining backup energy stations for supplementing energy; acquiring a node cost when the vehicle reaches each of the backup energy stations, and determining, according to an energy efficiency of the vehicle, an energy consumption of the vehicle when traveling on each of paths from the current location to the destination location. A travel route is planned for the vehicle according to the energy consumption of the vehicle when traveling on each of the paths, and the node cost when the vehicle reaches each of the backup energy stations.

### FIELD OF THE INVENTION

The present invention relates to the field of information processing technologies, and in particular, to a vehicle route planning method and apparatus.

### BACKGROUND OF THE INVENTION

With constant socio-economic development, vehicles are more and more popular. This brings great convenience to people's daily lives. When traveling via a vehicle, route planning is usually involved. When the travel range is long, energy supplies are also taken into consideration during planning of a travel route for the vehicle. For a fuel vehicle, suitable petrol or gas stations need to be selected. For an electric vehicle, suitable electric charging stations need to be selected. Therefore, regardless of the energy type of the electric vehicle, how to plan an economic energy supplement route is a problem to be solved.

In the prior art, during route planning for a vehicle, after a destination location and energy stations along the route of the vehicle are acquired, a node cost when the vehicle reaches each of the energy stations needs to be determined, where the node cost is an energy price; then an energy station with the lowest price according to the node costs of the energy stations is acquired; if the vehicle has sufficient energy to reach the energy station with the lowest price, the vehicle is supplemented with energy at the energy station with the lowest price; and if the vehicle does not have sufficiency energy to reach the energy station with the lowest price, the vehicle is supplemented with energy at an energy station before the energy station with the lowest price such that the vehicle can reach the energy station with the lowest price, and after the vehicle is supplemented with energy at the energy station with the lowest price, the subsequent energy stations are selected by using the same principle. In this way, a complete route to the destination location is planned.

During the implementation of the present invention, the inventors find that the prior art has at least the following problems:

In the prior art, during planning of an energy supplement route for the vehicle, the energy station with the lowest price needs to be selected according to the node prices of different energy stations for energy supplement, however, the energy cost saved when the vehicle is supplemented with energy at the energy station with the lowest price is sometimes higher than the energy cost of the vehicle to reach the energy station with the lowest energy station. In addition, while the energy station with the lowest price is being selected, selection of the subsequent energy stations is restricted such that the total energy cost is not the lowest. For example, the energy stations between the current location and the destination location include A, B, C, D, E, F, G, and H; if C is the energy station with the lowest price, the vehicle travels from the current location to B, and then from B to C, but still cannot directly reach the destination location after being supplemented with energy at C, the vehicle has to be supplemented with energy at E or F with a higher price. However, if the vehicle is supplemented with energy at B, and then supplemented with energy at G or H with a lower price compared with E and F, the total energy cost is lower than the total energy cost in the case where the vehicle travels via the route B to C to E to F to the destination location. Therefore, the route planned in the prior art is not optimal.

### SUMMARY OF THE INVENTION

To solve the technical problems in the prior art, embodiments of the present invention provide a vehicle route planning method and apparatus. The technical solutions are as follows:

In one aspect, a vehicle route planning method is provided, where the method includes:

acquiring a current location, a destination location, and an amount of remaining energy of a vehicle;

if energy needs to be supplemented for the vehicle to travel from the current location to the destination location, determining backup energy stations for supplementing energy;

acquiring a node cost when the vehicle reaches each of the backup energy stations, and determining, according to an energy efficiency of the vehicle, an energy consumption of the vehicle when traveling on each of paths from the current location to the destination location; and

planning a travel route for the vehicle according to the energy consumption of the vehicle when traveling on each of the paths, and the node cost when the vehicle reaches each of the backup energy stations.

The acquiring a node cost when the vehicle reaches each of the backup energy stations includes:

for any of the backup energy stations, estimating, according to the location of any of the backup energy stations, the time when the vehicle reaches the any of the backup energy stations; and

determining an energy price at any of the backup energy stations at the estimated time, and using the energy price as the node cost when the vehicle reaches any of the backup energy stations.

Furthermore, the planning a travel route for the vehicle according to the energy consumption of the vehicle when traveling on each of the paths, and the node cost when the vehicle reaches each of the backup energy stations includes:

selecting at least one final energy station from the backup energy stations, wherein the final energy station is a backup energy station where the vehicle is supplemented with energy such that the vehicle is capable of reaching the destination location;

for any of the at least one final energy station, calculating, according to an energy consumption of the vehicle when traveling between each of the previous energy stations of any of the at least one final energy station and any of the at least one final energy station and a node cost when the vehicle reaches each of the previous energy stations of any of the at least one final energy station, an energy cost when the vehicle travels from each of the previous energy stations of any of the at least one final energy station to any of the at least one final energy station, and selecting a previous energy station for any of the at least one final energy station from the previous energy stations of any of the at least one final energy station according to the energy costs;

starting from the previous energy station, continue to select a previous energy station by using the manner for selecting the previous energy station for any of the at least one final energy station, until reaching the current location, thereby obtaining candidate routes starting from any of the at least one final energy station; and

planning the route for the vehicle according to energy costs on the candidate routes.

Furthermore, prior to the calculating, according to an energy consumption of the vehicle when traveling between each of the previous energy stations of any of the at least one final energy station and any of the at least one final energy station and a node cost when the vehicle reaches each of the previous energy stations of any of the at least one final energy station, an energy cost when the vehicle travels from each of the previous energy stations of any of the at least one final energy station to any of the at least one final energy station, the method further includes:

for any of the backup energy stations, determining at least one candidate energy station for any of the backup energy stations according to a travel range of the vehicle with energy fully supplemented at any of the backup energy stations, and selecting, from the determined candidate energy stations, the candidate energy stations which the vehicle passes when traveling from the current location to the backup energy station, as previous energy stations of any of the backup energy stations.

Particularly, if no waypoint is designated between the current location and the destination location, the determining at least one candidate energy station for any of the backup energy stations according to a travel range of the vehicle with energy fully supplemented at any of the backup energy stations includes:

determining the travel range of the vehicle with energy fully supplemented at the any of the backup energy stations, and using the backup energy station(s) within the travel range of the vehicle and within an energy supplement range of the vehicle as the candidate energy station(s) of the any of the backup energy stations.

Particularly, if at least one waypoint is designated between the current location and the destination location, the determining at least one candidate energy station for any of the backup energy stations according to a travel range of the vehicle with energy fully supplemented at any of the backup energy stations includes:

determining the travel range of the vehicle with energy fully supplemented at any of the backup energy stations, and if at least one waypoint is within the travel range, using the backup energy station(s) which the vehicle with energy fully supplemented at any of the backup energy stations reaches after passing the at least one waypoint as the candidate energy station(s) of any of the backup energy stations.

Furthermore, the calculating, according to an energy consumption of the vehicle when traveling between each of the previous energy stations of any of the at least one final energy station and the final energy station and a node cost when the vehicle reaches each of the previous energy stations of any of the at least one final energy station, an energy cost when the vehicle travels from each of the previous energy stations of any of the at least one final energy station to any of the at least one final energy station, includes:

determining, according to the amount of remaining energy of the vehicle and the node cost when the vehicle reaches each of the backup energy stations, an amount of energy to be supplemented for the vehicle at each of the backup energy stations;

calculating, according to the amount of energy supplemented for the vehicle at each of the previous energy stations of any of the at least one final energy station and the node cost when the vehicle reaches each of the previous energy stations of any of the at least one final energy station, an energy cost when the vehicle travels from each of the previous energy stations to any of the at least one final energy station.

The planning the route for the vehicle according to an energy cost on each of the candidate routes includes:

for any of the candidate routes, determining, according to the amount of energy supplemented for the vehicle at each of the backup energy stations on any of the candidate routes and the node cost when the vehicle reaches each of the backup energy stations, an energy cost on any of the candidate routes, and planning the travel route for the vehicle according to the energy cost on each of the candidate routes and the amount of energy supplemented for the vehicle at each of the backup energy stations on each of the candidate routes.

In another aspect, a vehicle route planning apparatus is further provided, where the apparatus includes:

a first acquiring module, configured to acquire a current location, a destination location, and an amount of remaining energy of a vehicle;

a first determining module, configured to if energy needs to be supplemented for the vehicle to travel from the current location to the destination location acquired by the first acquiring module, determine backup energy stations for supplementing energy;

a second acquiring module, configured to acquire a node cost when the vehicle reaches each of the backup energy stations determined by the first determining module;

a second determining module, configured to determine, according to an energy efficiency of the vehicle, an energy consumption of the vehicle when traveling on each of the paths from the current location to the destination location; and

a planning module, configured to plan a travel route for the vehicle according to the energy consumption of the vehicle when traveling on each of the paths that is determined by the second determining module, and the node cost when the vehicle reaches each of the backup energy stations that is acquired by the second acquiring module.

The second acquiring module is further configured to for any of the backup energy stations, estimate, according to the location of the any of the backup energy stations, the time when the vehicle reaches any of the backup energy stations; and determine an energy price at any of the backup energy stations at the estimated time, and use the energy price as the node cost when the vehicle reaches any of the backup energy stations.

Furthermore, the planning module includes:

a first selecting unit, configured to select at least one final energy station from the backup energy stations, where the final energy station is a backup energy station where the vehicle is supplemented with energy such that the vehicle is capable of reaching the destination location;

a second selecting unit, configured to for any of the at least one final energy station, calculate, according to an energy consumption of the vehicle when traveling between each of the previous energy stations of any of the at least one final energy station and the any of the at least one final energy station and a node cost when the vehicle reaches each of the previous energy stations of any of the at least one final energy station, an energy cost when the vehicle travels from each of the previous energy stations to any of the at least one final energy station to any of the at least one final energy station, and select a previous energy station for any of the at least one final energy station from the previous energy stations of any of the at least one final energy station according to the energy costs; and starting from the previous energy station, continue to select a previous energy station of the previous energy station by using the manner for selecting the previous energy station for any of the at least one final energy station, until to the vehicle reaches the current location, thereby obtaining candidate routes starting from any of the at least one final energy station; and

a planning unit, configured to plan the route for the vehicle according to energy costs on the candidate routes selected by the second selecting unit.

Furthermore, the planning module further includes:

a determining unit, configured to, for any of the backup energy stations, determine at least one candidate energy station for the any of the backup energy stations according to a travel range of the vehicle with energy fully supplemented at the any of the backup energy station; and

a third selecting unit, configured to select, from the candidate energy stations determined by the determining unit, the candidate energy stations which the vehicle passes when traveling from the current location to the backup energy stations, as previous energy stations of any of the backup energy stations.

If no waypoint is designated between the current location and the destination location, the determining unit is further configured to determine the travel range of the vehicle with energy fully supplemented at any of the backup energy stations, and use the backup energy station(s) within the travel range of the vehicle and within an energy supplement range of the vehicle as the candidate energy station(s) of any of the backup energy stations.

Alternatively, if at least one waypoint is designated between the current location and the destination location, the determining unit is further configured to determine the travel range of the vehicle with energy fully supplemented at any of the backup energy stations, and if at least one waypoint is within the travel range, use the backup energy station(s) which the vehicle with energy fully supplemented at any of the backup energy stations reaches after passing the at least one waypoint as the candidate energy station(s) of any of the backup energy stations.

Furthermore, the second selecting unit is configured to determine, according to the amount of remaining energy of the vehicle and the node cost when the vehicle reaches each of the backup energy stations, an amount of energy to be supplemented for the vehicle at each of the backup energy stations; and calculate, according to the amount of energy supplemented for the vehicle at each of the previous energy stations of any of the at least one final energy station and the node cost when the vehicle reaches each of the previous energy stations of any of the at least one final energy station, an energy cost when the vehicle travels from each of the previous energy stations to any of the at least one final energy station.

The planning unit is configured to, for any of the candidate routes, determine, according to the amount of energy supplemented for the vehicle at each of the backup energy stations on the any of the candidate routes and the node cost when the vehicle reaches each of the backup energy stations, an energy cost on the any of the candidate routes, and plan the travel route for the vehicle according to the energy cost on each of the candidate routes and the amount of energy supplemented for the vehicle at each of the backup energy stations on each of the candidate routes.

The technical solutions provided in the embodiments of the present invention achieve the following beneficial effects:

According to the present invention, a travel route is planned for the vehicle according to the energy consumption of the vehicle when traveling on each of the paths between the current location and the target location, and the node cost when the vehicle reaches each of the backup energy stations. In this way, a global route planning is implemented such that a more optimal route is planned.

### BRIEF DESCRIPTION OF DRAWINGS

For a better understanding of the technical solutions in the embodiments of the present invention, the accompanying drawings for illustrating the embodiments are briefly described below. Evidently, the accompanying drawings in the following description illustrate only some embodiments of the present invention, and persons of ordinary skill in the art can derive other accompanying drawings from these accompanying drawings without any creative efforts.

FIG. 1 is a flowchart of a vehicle route planning method according to Embodiment 1 of the present invention;

FIG. 2 is a flowchart of a vehicle route planning method according to Embodiment 2 of the present invention;

FIG. 3 is a schematic diagram of backup energy stations according to Embodiment 2 of the present invention;

FIG. 4 is a schematic diagram of candidate energy stations according to Embodiment 2 of the present invention;

FIG. 5 is a schematic diagram of a planned route according to Embodiment 2 of the present invention;

FIG. 6 is another schematic diagram of candidate energy stations according to Embodiment 2 of the present invention;

FIG. 7 is a schematic diagram of another planned route according to Embodiment 2 of the present invention;

FIG. 8 is a schematic structural diagram of a vehicle route planning apparatus according to Embodiment 3 of the present invention;

FIG. 9 is a schematic structural diagram of a planning module according to the Embodiment 3 of the present invention; and

FIG. 10 is a schematic structural diagram of another planning module according to the Embodiment 3 of the present invention.

### DETAILED DESCRIPTION OF THE EMBODIMENTS

To make the objectives, technical solutions, and advantages of the present invention more understandable, the embodiments of the present invention are described in detail below with reference to the accompanying drawings.

### Embodiment 1

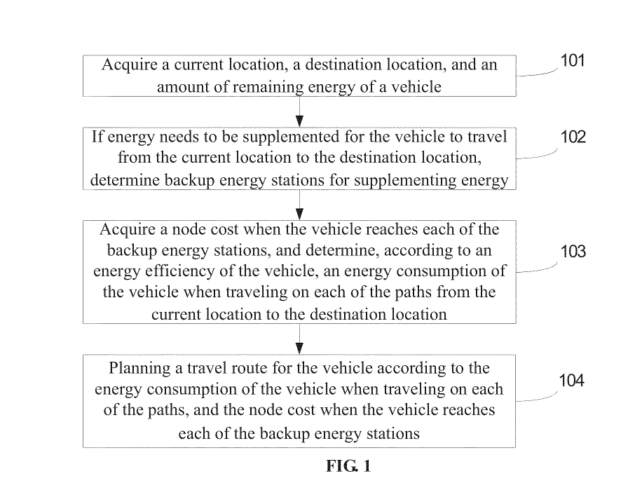

This embodiment provides a vehicle route planning method. Referring to FIG. 1, the method includes the following steps:

101: acquiring a current location, a destination location, and an amount of remaining energy of a vehicle;

102: if energy needs to be supplemented for the vehicle to travel from the current location to the destination location, determining backup energy stations for supplementing energy;

103: acquiring a node cost when the vehicle reaches each of the backup energy stations, and determining, according to an energy efficiency of the vehicle, an energy consumption of the vehicle when traveling on each of paths from the current location to the destination location; and

104: planning a travel route for the vehicle according to the energy consumption of the vehicle when traveling on each of the paths, and the node cost when the vehicle reaches each of the backup energy stations.

By using the method provided in this embodiment, a travel route is planned for the vehicle according to the energy consumption of the vehicle when traveling on each of the paths between the current location and the target location, and the node cost when the vehicle reaches each of the backup energy stations. In this way, a global route planning is implemented such that a more optimal route is planned.

To describe the method provided in Embodiment 1 more clearly, with reference to the description in the above embodiment, the vehicle route planning method is described by using the following embodiment.

### Embodiment 2

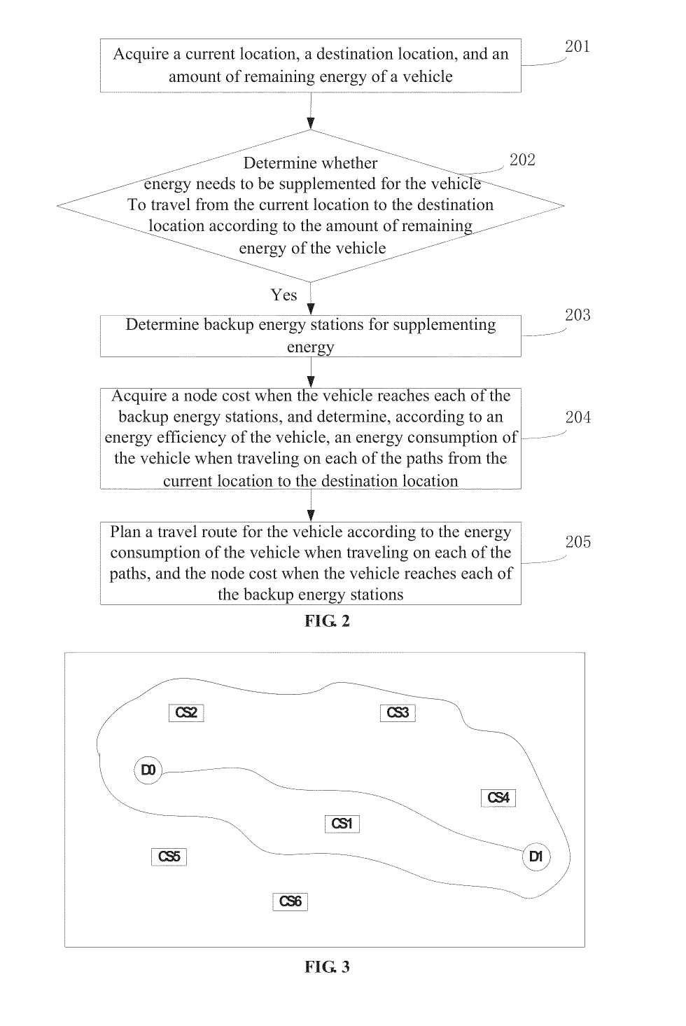

This embodiment provides a vehicle route planning method. Using the method, an optimal energy supplement method is planned by considering such factors as energy consumption and node cost. With reference to the description in Embodiment 1, referring to FIG. 2, the method provided in this embodiment includes the following steps:

201: Acquiring a current location, a destination location, and an amount of remaining energy of a vehicle.

The current location of the vehicle can be acquired by positioning the vehicle, for example, by using the global positioning system (GPS) or general packet radio service (GPRS). In addition, other positioning technologies and techniques for acquiring the current location of the vehicle may also be used. For example, the current location may be directed input by a user. This embodiment sets no limitation on the method for acquiring the current location of the vehicle.

Pluralities of methods are available for acquiring the destination location of the vehicle. For example, the destination location of the vehicle is acquired based on text information input by a user, or acquired based on information directly selected by the user on an electronic map, or acquired from history data of the vehicle. In addition, other methods for acquiring the destination location of the vehicle may also be used. This embodiment sets no limitation on the method for acquiring the destination location of the vehicle.

With respect to the method for acquiring the amount of remaining energy of the vehicle, since the most vehicles are provided with indicators indicating a real-time energy amount, the amount of remaining energy can be acquired according to the indicator. For example, the fuel vehicle is provided with an indicator for indicating fuel quantity, and the electric vehicle is provided with an indicator for indicating electricity quantity. Therefore, the amount of remaining energy can be acquired according to the indicator. Assuredly, other methods for acquiring the amount of remaining energy may also be used. This embodiment sets no limitation on the method for acquiring the amount of remaining energy.

202: Judging whether energy needs to be supplemented for the vehicle to travel from the current location to the destination location according to the amount of remaining energy of the vehicle, and if energy needs to be supplemented, performing step 203.

In this step, after the current location, the destination location, and the amount of remaining energy of the vehicle are acquired in step 201, judging whether energy needs to be supplemented for the vehicle to travel from the current location to the destination location may be implemented by using a plurality of methods, including but not limited to: determining energy consumption of the vehicle when traveling from the current location to the destination location, and then comparing whether the amount of remaining energy is larger than the energy consumption needed for the vehicle; and if smaller, judging that energy needs to be supplemented for the vehicle, and performing step 203.

203: Determining backup energy stations for supplementing energy.

Particularly, if fuel is to be supplemented for the vehicle, the backup energy stations include but are not limited to fuel stations, such as petrol stations or gas stations; if electric energy is to be supplemented for the vehicle, the backup energy stations include but are not limited to electric charging stations. The methods for determining the backup energy stations for supplementing energy include but are not limited to: determining an energy supplement range according to a travel plan of the user, and further determining the backup energy stations within the energy compensation range. The energy supplement range may be determined according to factors such as waypoints and destination locations selected by the user, acceptable detour distances for energy supplements, and distribution of and number of energy stations. The supplement range may be a region of a specific shape, such as a circle, an ellipse, a rectangle, an irregular polygon, or other shapes. As illustrated in FIG. 3, according to the travel plan set by the user, D0 and D1 are the current location and the destination location respectively. The closed area of the polygon shown in the curved lines of the polygon is the energy supplement range of the vehicle, within which the backup energy stations include CS1, CS2, CS3, and CS4.

204: Acquiring a node cost when the vehicle reaches each of the backup energy stations, and determining, according to an energy efficiency of the vehicle, an energy consumption of the vehicle when traveling on each of paths from the current location to the destination location.

In this step, price differences or quality differences exist between different backup energy stations; and for the same backup energy station, the price may fluctuate at different times (for example, the peak-valley electricity price). To plan a cost-efficient route, the time when the vehicle reaches the related backup energy stations needs to be estimated so that the energy price when the vehicle reaches each of the backup energy stations can be determined. In addition, to ensure energy quality during planning of the cost-efficient route, the energy quality of each of the backup energy stations can be determined. The method for planning a route based on the energy quality and energy price is the same as the method for planning a route based on the energy price in terms of principle. To be specific, during determining of the backup energy stations, the energy stations satisfying the energy quality are used as backup energy stations. The method for acquiring a node cost when the vehicle reaches each of the backup energy stations includes but is not limited to:

for each of the backup energy stations, estimating, according to the location of each of the backup energy stations, the time when the vehicle reaches the backup energy station; and

determining an energy price at each of the backup energy stations at the estimated time, and using the energy price as the node cost when the vehicle reaches each of the backup energy stations.

The estimating, according to the location of each of the backup energy stations, the time when the vehicle reaches the backup energy station includes but is not limited to: estimating the time when the vehicle reaches the backup energy station based on the location of each of the backup energy stations, traffic information, weather information, vehicle load information, and history information of traveling of the vehicle.

Furthermore, the energy efficiency of the vehicle refers to the consumption per unit distance per vehicle, including but not limited to fuel efficiency or electricity efficiency. The fuel efficiency refers to distance traveled per unit of fuel consumed, and the electricity efficiency refers to distance traveled per unit of electricity consumed. The energy efficiency of the vehicle may be acquired by collecting related data of the vehicle. The related data of the vehicle includes but is not limited to vehicle load, weather, traffic condition, road condition, history fuel efficiency, and the like. During calculation of the energy consumption of the vehicle when traveling on each of the paths between the current location and the destination location, the energy consumption of the vehicle when traveling on each of the paths is acquired according to the quotient of the length of each of the paths and the energy efficiency of the vehicle. For example, for a fuel vehicle, if the energy efficiency of the vehicle is 14 km/L, the energy consumption of the vehicle when traveling on a path having a length of 100 km is 100/14=7.14 L. To be specific, 7.14 L fuel is consumed by the vehicle when traveling 100 km. For an electric vehicle, if the energy efficiency of the vehicle is 10 kWh/L, the energy consumption of the vehicle when traveling on a path having a length of 100 km is 100/10=10 kWh. To be specific, 10 kWh electricity is consumed by the vehicle when traveling 100 km.

205: Planning a travel route for the vehicle according to the energy consumption of the vehicle when traveling on each of the paths, and the node cost when the vehicle reaches each of the backup energy stations.

Particularly, a plurality of methods are available for planning a travel route for the vehicle according to the energy consumption of the vehicle when traveling on each of the paths and the node cost when the vehicle reaches each of the candidate energy stations. For example, all possible routes of the vehicle from the current location to the target location are determined first, then the energy cost when the vehicle reaches each of the backup energy stations and the energy consumption of the vehicle when traveling on the corresponding path are calculated, and finally a route with lowest energy cost is selected from the routes.

In addition, the vehicle, after being supplemented with energy at a backup energy station closer to the destination location, can directly reach the destination location without further energy supplement. And the energy consumption of the vehicle when traveling from the backup energy station closer to the destination location is definite. Therefore, the method according to this embodiment further provides a way of reversely planning a route from the destination location to the current location. To implement the reverse route planning, the method provided in this embodiment further includes a step of determining previous energy stations for each of the backup energy stations, such that the route is planned backwards. Particularly, during determining of the previous energy stations for each of the backup energy stations, for any of the backup energy stations, at least one candidate energy station is determined for the backup energy station according to a travel range of the vehicle with energy fully supplemented at the any of the backup energy stations; and from the determined candidate energy station(s), candidate energy station(s) which the vehicle passes when traveling from the current location to the any of the backup energy station are selected as previous energy station(s) of the any of the backup energy stations.

The determining of at least one candidate energy station for the backup energy station according to a travel range of the vehicle with energy fully supplemented at the backup energy station includes but is not limited to the following two cases:

Case 1:

If no waypoint is designated between the current location and the destination location, the travel range of the vehicle with energy fully supplemented at the backup energy station is determined, and the backup energy station(s) within the travel range of the vehicle and within an energy supplement range of the vehicle as the candidate energy station(s) of the backup energy station is determined.

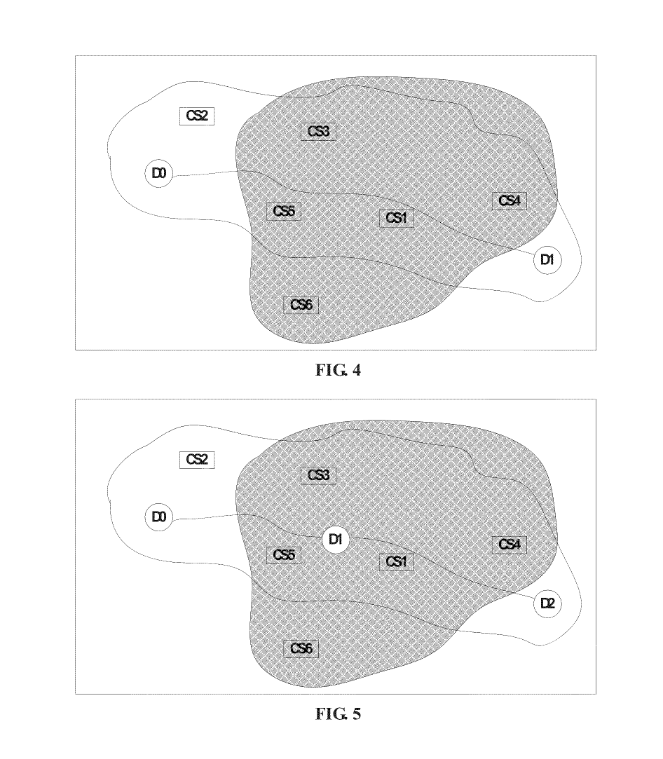

Case 1 is described by using the case illustrated in FIG. 4 as an example where the closed area of the polygon shown in the curved line is the energy supplement range of the vehicle. Assume that the vehicle is fully supplemented with energy at CS1, and the shaded area is the travel range R1 of the vehicle, backup energy stations CS3, CS4, and CS5 within both the travel range R1 and the energy supplement range of the vehicle are the candidate energy stations of CS1. Since the vehicle passes CS5 and CS3 when traveling from the current location D0 to the backup energy station CS1, CS3 and CS5 are used as previous energy stations of the backup energy station CS1.

Case 2:

If at least one waypoint is designated between the current location and the destination location, the travel range of the vehicle with energy fully supplemented at the backup energy station is determined; and if at least one waypoint is within the travel range, the backup energy station(s) which the vehicle with energy fully supplemented at any of the backup energy stations reaches after passing the at least one waypoint is used as the candidate energy station(s) of the any of the backup energy stations.

In case 2, the waypoint is a waypoint which the vehicle must pass when traveling from the current location to the destination location, which may be interpreted as an intermediate destination location. Case 2 is described by using the case illustrated in FIG. 5 as an example where the closed area of the polygon shown in the curved line is the energy supplement range of the vehicle. Assume that the vehicle is fully supplemented with energy at CS1, the shaded area is the travel range R1 of the vehicle, the travel range includes a waypoint D1, backup energy stations CS3, CS4, and CS5 are within both the travel range R1 and the energy supplement range of the vehicle. If the vehicle with energy fully supplemented at CS1 can reach, through D1, CS3 and CS5, CS3 and CS5 are candidate energy stations of the backup energy station CS1. Using the case where both CS3 and CS5 are candidate energy stations of CS1 as an example, since the candidate energy stations which the vehicle passes when traveling from the current location D0, through the waypoint D1, to the backup energy station CS1 are CS3 and CS5. CS3 and CS5 are used as previous energy stations of the backup energy station CS1.

Further, in the two cases above for determining previous energy stations for each of the backup energy stations, the planning the route for the vehicle according to an energy cost on each of the candidate routes includes but is not limited to the following steps:

selecting at least one final energy station from the backup energy stations, where the final energy station is a backup energy station where the vehicle is supplemented with energy such that the vehicle is capable of reaching the destination location;

for any of the at least one final energy station, calculating, according to an energy consumption of the vehicle when traveling between each of the previous energy stations and the final energy station and a node cost when the vehicle reaches each of the previous energy stations of the final energy station, an energy cost when the vehicle travels from each of the previous energy stations to the final energy station, and selecting a previous energy station from the previous energy stations for the final energy station according to the energy costs;

starting from the previous energy station, and selecting a previous energy station for the previous energy station by using the method for selecting the previous energy station for the final energy station, until the vehicle reaches the current location, thereby obtaining candidate routes starting from the final energy station; and

planning the route for the vehicle according to an energy cost on each of the candidate routes.

Furthermore, the calculating, according to an energy consumption of the vehicle when traveling between each of previous energy stations and the final energy station and a node cost when the vehicle reaches each of the previous energy stations of the final energy station, an energy cost when the vehicle travels from each of the previous energy stations to the final energy station, includes:

determining, according to the amount of remaining energy of the vehicle and the node cost when the vehicle reaches each of the backup energy stations, an amount of energy to be supplemented for the vehicle at each of the backup energy stations;

calculating, according to the amount of energy supplemented for the vehicle at each of the previous energy stations of the final energy station and the node cost when the vehicle reaches each of the previous energy stations of the final energy station, an energy cost when the vehicle travels from each of the previous energy stations to the final energy station.

Correspondingly, the planning of the route for the vehicle according to an energy cost on each of the candidate routes includes:

for any of the candidate routes, determining, according to the amount of energy supplemented for the vehicle at each of the backup energy stations on any one of the candidate routes and the node cost when the vehicle reaches each of the backup energy stations, an energy cost on any of the candidate routes, and planning the travel route for the vehicle according to the energy cost on each of the candidate routes and the amount of energy supplemented for the vehicle at each of the backup energy stations on each of the candidate routes.

It should be noted that the determining, according to the amount of remaining energy of the vehicle and the node cost when the vehicle reaches each of the backup energy stations, an amount of energy to be supplemented for the vehicle at each of the backup energy stations is performed in but is not limited to the following ways:

If two, or more than two, backup energy stations are in the route, any two neighbor backup energy stations A and B are selected. In addition, it is known that node costs when the vehicle reaches A and B are PA and PB respectively. If PA is smaller than PB, the vehicle is fully supplemented with energy at the backup energy station A; otherwise, the vehicle is only partially supplemented with energy at the backup energy station A to ensure that the vehicle has sufficient energy to reach the backup energy station B.

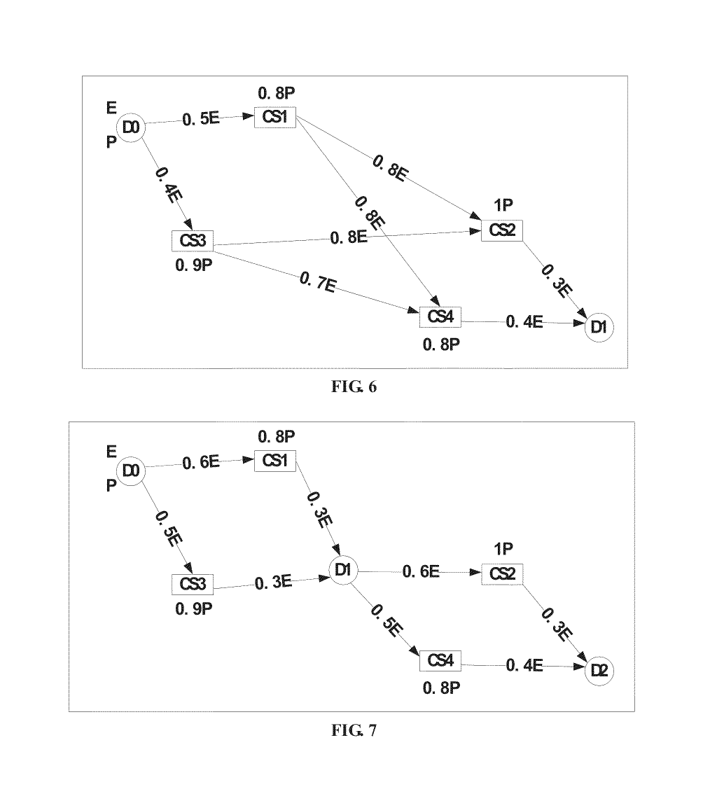

In the case where no waypoint is designated between the current location and the destination location, the method for planning a route is described by using the example as illustrated in FIG. 6 to make it easy to understand. As illustrated in FIG. 6, the amount of remaining energy of the vehicle at the current location D0 is E, where E is the total amount of energy of the vehicle with energy fully supplemented, and the price of the remaining energy is P. The node cost when the vehicle reaches each of the backup energy stations and the corresponding energy consumption are illustrated in FIG. 6.

On the route D0->CS1->CS2->D1, since CS1 and CS2 are neighbor energy stations, and the node cost 0.8P when the vehicle reaches CS1 is lower than the node cost 1P of the vehicle to reach CS2, then the vehicle can be fully supplemented with energy at CS1. In addition, since the amount of remaining energy of the vehicle at the current location D0 is E, and the energy consumption of the vehicle when traveling from D0 to CS1 is 0.5E, then the amount of remaining energy of the vehicle after traveling from D0 to CS1 is 0.5E. If the vehicle is fully supplemented with energy at CS1, the amount of energy supplemented for the vehicle at CS1 is 0.5E. After the vehicle travels from CS1 to CS2, since the energy consumption from CS1 to CS2 is 0.8E, the amount of remaining energy of the vehicle after traveling from CS1 to CS2 is 0.2E. However, the energy consumption of the vehicle when traveling from CS2 to the destination location D1 is 0.3E. Therefore, to ensure that the vehicle can travel from CS2 to the destination location D1, the amount of energy supplemented for the vehicle at CS2 is 0.1E. The amount of energy supplemented for the vehicle at each of the backup energy stations may be determined according to the method for determining the amount of energy supplemented for the vehicle at CS1 and CS2. As illustrated in FIG. 6, on the route D0->CS3->CS2->D1, the amount of energy supplemented for the vehicle at CS3 is 0.4E; for the route D0->CS3->CS4->D1, the amount of energy supplemented for the vehicle at CS3 is 0.1E; for the route D0->CS1->CS4->D1, the amount of energy supplemented for the vehicle at CS1 is 0.3E, and the amount of energy supplemented for the vehicle at CS4 is 0.4E.

Furthermore, for the routes illustrated in FIG. 6, using the case where the determined final energy nodes are CS2 and CS4, the previous energy stations of CS2 are CS1 and CS3, and the previous energy stations of CS4 are CS1 and CS3 as an example, candidate routes starting from CS2 and starting from CS4 can be respectively acquired.

The candidate routes starting from CS2 are determined as follows:

On the route D0->CS1->CS2->D1, since the amount of energy supplemented for the vehicle at CS1 is 0.5E, and the energy price of when the vehicle reaches CS1 is 0.8P, the energy cost from CS1 to CS2 is 0.5E×0.8P=0.4EP. On the route D0->CS3->CS2->D1, since the amount of energy supplemented for the vehicle at CS2 is 0.4E, and the energy price when the vehicle reaches CS3 is 0.9P, the energy cost from CS3 to CS2 is 0.4E×0.9P=0.36EP. Since the energy cost 0.4EP from CS1 to CS2 is higher than the energy cost 0.36EP from CS3 to CS2, CS3 is selected as a previous energy station of CS2.

Starting from CS3, a previous energy station is selected for CS3 by using the method of selecting a previous energy station for CS2. Using the case as illustrated in FIG. 6 where CS3 can directly reach the current location D0, a candidate route starting from CS2 is:

D0->CS3->CS2->D1.

Since the cost of the remaining energy of the vehicle at the current location has been paid, during subsequent route planning, the energy cost of the vehicle when traveling from D0 to CS3 is ignored. In this case, according to node costs when the vehicle reaches CS2 and CS3 and amounts of energy supplemented for the vehicle at CS3 and CS2, the energy cost on the candidate route D0->CS3->CS2->D1 starting from CS2 is: 0.4E×0.9P+0.1E×1P=0.46EP.

The candidate routes starting from CS4 are determined as follows:

On the route D0->CS1->CS4->D1, since the node costs when the vehicle reaches CS1 and CS3 are both 0.8P, and this embodiment uses the case where the vehicle is partially supplemented with energy at CS1 such that the vehicle can reach CS4 as an example for description, the amount of energy supplemented for the vehicle at CS1 is 0.3E, the energy price when the vehicle reaches CS1 is 0.8P, then the energy cost from CS1 to CS4 is 0.3E×0.8P=0.24EP. On the route D0->CS3->CS4->D1, since the amount of energy supplemented for the vehicle at CS3 is 0.1E, and the energy price when the vehicle reaches CS3 is 0.9P, then the energy cost from CS3 to CS4 is 0.1E×0.9P=0.09EP. Since the energy cost 0.24EP from CS1 to CS4 is higher than the energy cost 0.09EP from CS3 to CS4, CS3 is selected as the previous energy station of CS4.

Starting from CS3, a previous energy station is selected for CS3 by using the method for selecting CS3. Using the case where CS3 as illustrated in FIG. 6 can directly reach the current location D0, a candidate route starting from CS4 is:

D0->CS3->CS4->D1.

Since the cost of the remaining energy of the vehicle at the current location has been paid, then during subsequent route planning, the energy cost of the vehicle when traveling from D0 to CS3 is ignored. In this case, according to node costs when the vehicle reaches CS3 and CS4 and amounts of energy supplemented for the vehicle at CS3 and CS4, the energy cost on the candidate route D0->CS3->CS4->D1 starting from CS4 is: 0.1E×0.9P+0.4E×0.8P=0.41EP.

In conclusion, since the energy cost on the route D0->CS1->CS2->D1 is 0.46EP, and the energy cost on the route D0->CS3->CS4->D1 is 0.41EP, then the planned cost-efficient energy supplement route is D0->CS3->CS4->D1. The amount of energy supplemented for the vehicle at CS3 is 0.1E, and the amount of energy supplemented for the vehicle at CS4 is 0.4E

In the case where at least one waypoint is designated between the current location and the destination location, the method for planning a route is described by using the example as illustrated in FIG. 7 for ease of understanding. As illustrated in FIG. 7, a waypoint is designated, the amount of remaining energy of the vehicle at the current location D0 is E, where E is the total amount of energy of the vehicle with energy fully supplemented, and the price of the remaining energy is P. The node cost when the vehicle reaches each of the backup energy stations and the corresponding energy consumption are illustrated in FIG. 7.

On the route D0->CS1->D1->CS2->D2, since CS1 and CS2 are neighbor energy stations, and the node cost 0.8P of the vehicle to reach CS1 is lower than the node cost 1P of the vehicle to reach CS2, the vehicle can be fully supplemented with energy at CS1. In addition, since the energy consumption from D0 to CS1 is 0.6E, the amount of remaining energy of the vehicle after traveling from D0 to CS1 is 0.4E. If the vehicle is fully supplemented with energy at CS1, the amount of energy supplemented for the vehicle at CS1 is 0.6E. After the vehicle travels from CS1, through D1, to CS2, since the energy consumption from CS1, through D1, to CS2 is 0.3E+0.6E=0.9E, the amount of remaining energy of the vehicle after traveling from CS1, through D1, to CS2 is 0.1E, and the energy consumption of the vehicle when traveling from CS2 to the destination location D1 is 0.3E. Therefore, to ensure that the vehicle can travel from CS2 to the destination location D2, the amount of energy supplemented for the vehicle at CS2 is 0.2E. The amount of energy supplement at each of the backup energy stations may be determined according to the method for determining the amount of energy supplement at CS1 and CS2. As illustrated in FIG. 7, on the route D0->CS3->D1->CS2->D2, the amount of energy supplemented for the vehicle at CS3 is 0.5E; on the route D0->CS3->D1->CS4->D2, the amount of energy supplemented for the vehicle at CS3 is 0.3E, and the amount of energy supplemented for the vehicle at CS4 is 0.4E; on the route D0->CS1->D1->CS4->D2, the amount of energy supplemented for the vehicle at CS1 is 0.4E, and the amount of energy supplemented for the vehicle at CS4 is 0.4E.

Furthermore, with respect to the routes illustrated in FIG. 7, using the case where the determined final energy nodes are CS2 and CS4, the previous energy stations of CS2 are CS1 and CS3, and the previous energy stations of CS4 are CS1 and CS3 as an example, candidate routes starting from CS2 and starting from CS4 can be respectively acquired.

The candidate routes starting from CS2 are determined as follows:

On the route D0->CS1->D1->CS2->D2, since the amount of energy supplemented for the vehicle at CS1 is 0.6E, and the node price of the vehicle to reach CS1 is 0.8P, the energy cost from CS1, through D1, to CS2 is 0.6E×0.8P=0.48EP. On the route D0->CS3->D1->CS2->D2, since the amount of energy supplemented for the vehicle at CS2 is 0.5E, and the node price of the vehicle to reach CS3 is 0.9P, the energy cost from CS3 to CS2 is 0.5E×0.9P=0.45EP. Since the energy cost 0.48EP from CS1, through D1, to CS2 is higher than the energy cost 0.45P from CS3, through D1, to CS2, CS3 is selected as a previous energy station of CS2.

Starting from CS3, a previous energy station is selected for CS3 by using the manner for selecting CS3. Using the case where CS3 as illustrated in FIG. 7 can directly reach the current location D0, a candidate route starting from CS2 is:

D0->CS3->D1->CS2->D2.

Since the remaining energy of the vehicle at the current location has used the energy cost, during subsequent route planning, the case where the energy cost of the vehicle when traveling from D0 to CS3 is ignored, is used an example. In this case, according to node costs when the vehicle reaches CS3 and CS2 and amounts of energy supplemented for the vehicle at CS3 and CS2, the energy cost on the candidate route D0->CS3->D1->CS2->D2 starting from CS2 is: 0.5E×0.9P+0.2E×1P=0.65EP.

The candidate routes starting from CS4 are determined as follows:

On the route D0->CS1->D1->CS4->D2, since node costs when the vehicle reaches CS1 and CS4 are both 0.8P, and this embodiment uses the case where the vehicle is partially supplemented with energy at CS1 such that the vehicle can reach CS4 as an example for description, the amount of energy supplemented for the vehicle at CS1 is 0.4E, the energy price when the vehicle reaches CS1 is 0.8P, and the energy cost from CS1, through D1, to CS4 is 0.4E×0.8P=0.32EP. On the route D0->C53->D1->C54->D2, since the amount of energy supplemented for the vehicle at CS3 is 0.3E, and the node price when the vehicle reaches CS3 is 0.9P, the energy cost from CS3, through D1, to CS4 is 0.3E×0.9P=0.27EP. Since the energy cost 0.32EP from CS1, through D1, to CS4 is higher than the energy cost 009EP from CS3, through D1, to CS4, CS3 is selected as a previous energy station of CS4.

Starting from CS3, a previous energy station is selected for CS3 by using the manner for selecting CS3. Using the case where CS3 as illustrated in FIG. 7 can directly reach the current location D0, a candidate route starting from CS4 is:

D0->CS3->D1->CS4->D2.

Since the remaining energy of the vehicle at the current location has used out the energy cost, during subsequent route planning, the case where the energy cost of the vehicle when traveling from D0 to CS3 is ignored is used an example. In this case, according to node costs when the vehicle reaches CS3 and CS4 and amounts of energy supplemented for the vehicle at CS3 and CS4, the energy cost on the candidate route D0->C53->D1->C54->D2 starting from CS4 is: 0.3E×0.9P+0.4E×0.8P=0.59EP.

In conclusion, since the energy cost on the route D0->C53->D1->C52->D2 is 0.65EP, and the energy cost on the route D0->C53->D1->C54->D2 is 0.59EP, a planned cost-efficient energy supplement route is D0->CS3->D1->C54->D2. The amount of energy supplemented for the vehicle at CS3 is 0.3E, and the amount of energy supplemented for the vehicle at CS4 is 0.4E.

By using the method provided in this embodiment, a travel route is planned for the vehicle according to the energy consumption of the vehicle when traveling on each of the paths between the current location and the target location, and the node cost when the vehicle reaches each of the backup energy stations. In this way, a global route planning is implemented such that a more optimal route is planned. In addition, since the energy consumption of the vehicle when traveling from each of the final energy stations to the target location is definite, candidate routes are determined starting from each of the final energy stations, and then a route is planned for the vehicle according to the energy cost on each of the candidate routes. In this way, the calculation workload is reduced and the speed of route planning is improved.

### Embodiment 3

This embodiment provides a vehicle route planning apparatus for performing the method illustrated in Embodiment 1 or 2. Referring to FIG. 8, the apparatus includes:

a first acquiring module 81, configured to acquire a current location, a destination location, and an amount of remaining energy of a vehicle;

a first determining module 82, configured to if energy needs to be supplemented for the vehicle to travel from the current location to the destination location acquired by the first acquiring module 81, determine backup energy stations for supplementing energy;

a second acquiring module 83, configured to acquire a node cost when the vehicle reaches each of the backup energy stations determined by the first determining module 82;

a second determining module 84, configured to determine, according to an energy efficiency of the vehicle, an energy consumption of the vehicle when traveling on each of paths from the current location to the destination location; and

a planning module 85, configured to plan a travel route for the vehicle according to the energy consumption of the vehicle when traveling on each of the paths that is determined by the second determining module 84, and the node cost when the vehicle reaches each of the backup energy stations that is acquired by the second acquiring module 83.

The second acquiring module 83 is further configured to for any of the backup energy stations, estimate, according to the location of each of the backup energy stations, the time when the vehicle reaches the backup energy station; and determine the energy price at each of the backup energy stations at the estimated time, and use the energy price as the node cost when the vehicle reaches each of the backup energy stations.

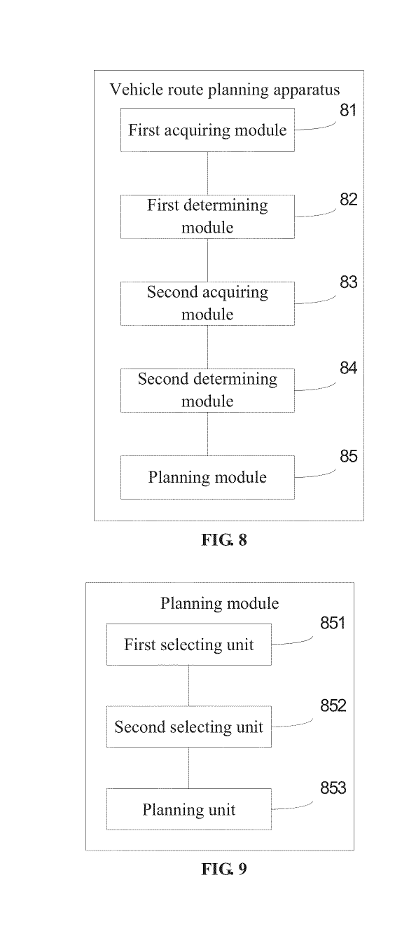

Furthermore, referring to FIG. 9, the planning module 85 includes:

a first selecting unit 851, configured to select at least one final energy station from the backup energy stations, where the final energy station is a backup energy station at which the vehicle is supplemented with energy such that the vehicle is capable of reaching the destination location;

a second selecting unit 852, configured to for any of the at least one final energy station selected by the first selecting unit 851, calculate, according to an energy consumption of the vehicle when traveling between each of previous energy stations of the final energy station and the any of the at least one final energy station and a node cost when the vehicle reaches each of the previous energy stations of the final energy station, an energy cost when the vehicle travels from each of the previous energy stations to the final energy station to the any of the at least one final energy station, and select a previous energy station for the any of the at least one final energy station from the previous energy stations of the final energy station according to the energy costs; and starting from the previous energy station, continue to select a previous energy station of the previous energy station by using the manner for selecting the previous energy station for the final energy station, until to the vehicle reaches the current location, thereby obtaining candidate routes starting from the final energy station; and

a planning unit 853, configured to plan the route for the vehicle according to energy costs on the candidate routes selected by the second selecting unit 852.

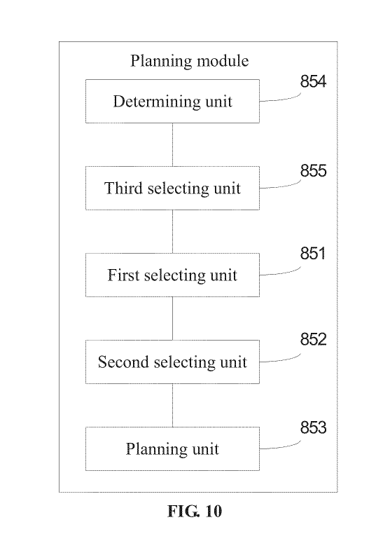

Furthermore, referring to FIG. 10, the planning module 85 further includes:

a determining unit 854, configured to for any of the backup energy stations, determine at least one candidate energy station for the backup energy station according to a travel range of the vehicle with energy fully supplemented at the backup energy station; and

a third selecting unit 855, configured to select, from the candidate energy stations determined by the determining unit 854, the candidate energy stations which the vehicle passes when traveling from the current location to the backup energy station, as previous energy stations of the backup energy station.

Furthermore, if no waypoint is designated between the current location and the destination location, the determining unit 854 is further configured to determine the travel range of the vehicle with energy fully supplemented at the any of the backup energy stations, and use the backup energy station(s) within the travel range of the vehicle and within an energy supplement range of the vehicle as the candidate energy station(s) of the any of the backup energy station.

Alternatively, if at least one waypoint is designated between the current location and the destination location, the determining unit 854 is further configured to determine the travel range of the vehicle with energy fully supplemented at the backup energy stations, and if at least one waypoint is within the travel range, use the backup energy station(s) which the vehicle with energy fully supplemented at the backup energy station reaches after passing the at least one waypoint as the candidate energy station(s) of the backup energy station.

Furthermore, the second selecting unit 852 is configured to determine, according to the amount of remaining energy of the vehicle and the node cost when the vehicle reaches each of the backup energy stations, an amount of energy to be supplemented for the vehicle at each of the backup energy stations; and calculate, according to the amount of energy supplemented for the vehicle at each of the previous energy stations of the any of the at least one final energy station and the node cost when the vehicle reaches each of the previous energy stations of the any of the at least one final energy station, an energy cost when the vehicle travels from each of the previous energy stations to the any of the at least one final energy station.

The planning unit 853 is configured to for any of the candidate routes, determine, according to the amount of energy supplemented for the vehicle at each of the backup energy stations on the candidate route and the node cost when the vehicle reaches each of the backup energy stations, an energy cost on the any of the candidate routes, and plan the travel route for the vehicle according to an energy cost on each of the candidate routes and the amount of energy supplemented for the vehicle at each of the backup energy stations on each of the candidate routes.

In conclusion, by using the apparatus provided in this embodiment, a travel route is planned for the vehicle according to the energy consumption of the vehicle when traveling on each of the paths between the current location and the target location, and the node cost when the vehicle reaches each of the backup energy stations. In this way, a global route planning is implemented such that a more optimal route is planned. In addition, since the energy consumption of the vehicle when traveling from each of the final energy stations to the target location is definite, candidate routes are determined starting from each of the final energy stations, and then a route is planned for the vehicle according to the energy cost on each of the candidate routes. In this way, the calculation workload is reduced and the speed of route planning is improved.

It should be noted that, during vehicle route planning, the vehicle router planning apparatus according to the above embodiments is only described by only using division of the above functional modules for description. In practice, the functions may be assigned to different functional modules for implementation as required. To be specific, the internal structure of the apparatus is divided into different functional modules to implement all or part of the above-described functions. In addition, the vehicle router planning apparatus and the vehicle router planning method according to the above embodiments pertain to the same concept, where the specific implementation is elaborated in the method embodiments, which is not to be detailed herein any further.

The sequence numbers of the preceding embodiments of the present invention are only for ease of description, but do not denote the preference of the embodiments. A person skilled in the art should understand that all or part of steps of the preceding methods may be implemented by hardware or hardware following instructions of programs. The programs may be stored in a computer readable storage medium. The storage medium may be a read only memory, a magnetic disk, or a compact disc-read only memory.

Described above are merely preferred embodiments of the present invention, but are not intended to limit the present invention. Any modification, equivalent replacement, or improvement made without departing from the spirit and principle of the present invention should fall within the protection scope of the present invention.

What is claimed is:

1. A vehicle route planning method, comprising:
acquiring a current location, a destination location, and an amount of remaining energy of a vehicle;
if energy needs to be supplemented for the vehicle to travel from the current location to the destination location, determining backup energy stations for supplementing energy;
acquiring a node cost when the vehicle reaches each of the backup energy stations, and determining, according to an energy efficiency of the vehicle, an energy consumption of the vehicle when traveling on each of paths from the current location to the destination location; and
planning a travel route for the vehicle according to the energy consumption of the vehicle when traveling on each of the paths, and the node cost when the vehicle reaches each of the backup energy stations.

2. The method according to claim 1, wherein the acquiring a node cost when the vehicle reaches each of the backup energy stations comprises:
for any of the backup energy stations, estimating, according to the location of the any of the backup energy stations, the time when the vehicle reaches the any of the backup energy stations; and
determining an energy price at the any of the backup energy stations at the estimated time, and using the energy price as the node cost when the vehicle reaches the any of the backup energy stations.

3. The method according to claim 1, wherein the planning a travel route for the vehicle according to the energy consumption of the vehicle when traveling on each of the paths, and the node cost when the vehicle reaches each of the backup energy stations, comprises:
selecting at least one final energy station from the backup energy stations, wherein the final energy station is a backup energy station where the vehicle is supplemented with energy such that the vehicle is capable of reaching the destination location;
for any of the at least one final energy station, calculating, according to an energy consumption of the vehicle when traveling between each of the previous energy stations of the any of the at least one final energy station and the any of the at least one final energy station and a node cost when the vehicle reaches each of the previous energy stations of the any of the at least one final energy station, an energy cost when the vehicle travels from each of the previous energy stations of the any of the at least one final energy station to the any of the at least one final energy station, and selecting a previous energy station for the any of the at least one final energy station from the previous energy stations of the any of the at least one final energy station according to the energy costs;
starting from the previous energy station, continue to select a previous energy station of the previous energy station by using the manner for selecting the previous energy station for the any of the at least one final energy station, until to the current location, thereby obtaining candidate routes starting from the any of the at least one final energy station; and
planning the route for the vehicle according to energy costs on the candidate routes.

4. The method according to claim 3, wherein prior to the calculating, according to an energy consumption of the vehicle when traveling between each of the previous energy stations of the any of the at least one final energy station and the any of the at least one final energy station and a node cost when the vehicle reaches each of the previous energy stations of the any of the at least one final energy station, an energy cost when the vehicle travels from each of the previous energy stations of the any of the at least one final energy station to the any of the at least one final energy station, the method further comprises:
for any of the backup energy stations, determining at least one candidate energy station for the any of the backup energy stations according to a travel range of the vehicle with energy fully supplemented at the any of the backup energy stations, and selecting, from the determined candidate energy stations, the candidate energy stations which the vehicle passes when traveling from the current location to the backup energy station, as previous energy stations of the any of the backup energy stations.

5. The method according to claim 4, wherein if no waypoint is designated between the current location and the destination location, the determining at least one candidate energy station for the any of the backup energy stations according to a travel range of the vehicle with energy fully supplemented at the any of the backup energy stations comprises:
determining the travel range of the vehicle with energy fully supplemented at the any of the backup energy stations, and using the backup energy station(s) within the travel range of the vehicle and within an energy supplement range of the vehicle as the candidate energy station(s) of the any of the backup energy stations.

6. The method according to claim 4, wherein if at least one waypoint is designated between the current location and the destination location, the determining at least one candidate energy station for the any of the backup energy stations according to a travel range of the vehicle with energy fully supplemented at the any of the backup energy stations comprises:
determining the travel range of the vehicle with energy fully supplemented at the any of the backup energy stations, and if at least one waypoint is within the travel range, using the backup energy station(s) which the vehicle with energy fully supplemented at the any of the backup energy stations reaches after passing the at least one waypoint as the candidate energy station(s) of the any of the backup energy stations.

7. The method according to claim 3, wherein the calculating, according to an energy consumption of the vehicle when traveling between each of the previous energy stations of the any of the at least one final energy station and the final energy station and a node cost when the vehicle reaches each of the previous energy stations of the any of the at least one final energy station, an energy cost when the vehicle travels from each of the previous energy stations of the any of the at least one final energy station to the any of the at least one final energy station, comprises:
determining, according to the amount of remaining energy of the vehicle and the node cost when the vehicle reaches each of the backup energy stations, an amount of energy to be supplemented for the vehicle at each of the backup energy stations;
calculating, according to the amount of energy supplemented for the vehicle at each of the previous energy stations of the any of the at least one final energy station and the node cost when the vehicle reaches each of the previous energy stations of the any of the at least one final energy station, an energy cost when the vehicle travels from each of the previous energy stations to the any of the at least one final energy station;
the planning the route for the vehicle according to an energy cost on each of the candidate routes comprises:
for any of the candidate routes, determining, according to the amount of energy supplemented for the vehicle at each of the backup energy stations on the any of the candidate routes and the node cost when the vehicle reaches each of the backup energy stations, an energy cost on the any of the candidate routes, and planning the travel route for the vehicle according to the energy cost on each of the candidate routes and the amount of energy supplemented for the vehicle at each of the backup energy stations on each of the candidate routes.

8. A vehicle route planning apparatus, comprising:
a first acquiring module, configured to acquire a current location, a destination location, and an amount of remaining energy of a vehicle;
a first determining module, configured to if energy needs to be supplemented for the vehicle to travel from the current location to the destination location acquired by the first acquiring module, determine backup energy stations for supplementing energy;
a second acquiring module, configured to acquire a node cost when the vehicle reaches each of the backup energy stations determined by the first determining module;
a second determining module, configured to determine, according to an energy efficiency of the vehicle, an energy consumption of the vehicle when traveling on each of paths from the current location to the destination location; and
a planning module, configured to plan a travel route for the vehicle according to the energy consumption of the vehicle when traveling on each of the paths that is determined by the second determining module, and the node cost when the vehicle reaches each of the backup energy stations that is acquired by the second acquiring module.

9. The apparatus according to claim 8, wherein the second acquiring module is further configured to: for any of the backup energy stations, estimate, according to the location of the any of the backup energy stations, the time when the vehicle reaches the any of the backup energy stations; and determine an energy price at the any of the backup energy stations at the estimated time, and use the energy price as the node cost when the vehicle reaches the any of the backup energy stations.

10. The apparatus according to claim 8, wherein the planning module comprises:
a first selecting unit, configured to select at least one final energy station from the backup energy stations, wherein the final energy station is a backup energy station where the vehicle is supplemented with energy such that the vehicle is capable of reaching the destination location;
a second selecting unit, configured to: for any of the at least one final energy station, calculate, according to an energy consumption of the vehicle when traveling between each of the previous energy stations of the any of the at least one final energy station and the any of the at least one final energy station and a node cost when the vehicle reaches each of the previous energy stations of the any of the at least one final energy station, an energy cost when the vehicle travels from each of the previous energy stations to the any of the at least one final energy station to the any of the at least one final energy station, and select a previous energy station for the any of the at least one final energy station from the previous energy stations of the any of the at least one final energy station according to the energy costs; and starting from the previous energy station, continue to select a previous energy station of the previous energy station by using the manner for selecting the previous energy station for the any of the at least one final energy station, until to the vehicle reaches the current location, thereby obtaining candidate routes starting from the any of the at least one final energy station; and
a planning unit, configured to plan the route for the vehicle according to energy costs on the candidate routes selected by the second selecting unit.

11. The device according to claim 10, wherein the planning module further comprises:
a determining unit, configured to: for any of the backup energy stations, determine at least one candidate energy station for the any of the backup energy stations according to a travel range of the vehicle with energy fully supplemented at the any of the backup energy station; and
a third selecting unit, configured to select, from the candidate energy stations determined by the determining unit, the candidate energy stations which the vehicle passes when traveling from the current location to the backup energy stations, as previous energy stations of the any of the backup energy stations.

12. The apparatus according to claim 11, wherein if no waypoint is designated between the current location and the destination location, the determining unit is further configured to determine the travel range of the vehicle with energy fully supplemented at the any of the backup energy stations, and use the backup energy station(s) within the travel range of the vehicle and within an energy supplement range of the vehicle as the candidate energy station(s) of the any of the backup energy stations.

13. The apparatus according to claim 11, wherein if at least one waypoint is designated between the current location and the destination location, the determining unit is further configured to determine the travel range of the vehicle with energy fully supplemented at the any of the backup energy stations, and if at least one waypoint is within the travel range, use the backup energy station(s) which the vehicle with energy fully supplemented at the any of the backup energy stations reaches after passing the at least one waypoint as the candidate energy station(s) of the any of the backup energy stations.

14. The apparatus according to claim 10, wherein the second selecting unit is configured to determine, according to the amount of remaining energy of the vehicle and the node cost when the vehicle reaches each of the backup energy stations, an amount of energy to be supplemented for the vehicle at each of the backup energy stations; and calculate, according to the amount of energy supplemented for the vehicle at each of the previous energy stations of the any of the at least one final energy station and the node cost when the vehicle reaches each of the previous energy stations of the any of the at least one final energy station, an energy cost when the vehicle travels from each of the previous energy stations to the any of the at least one final energy station; and
the planning unit is configured to: for any of the candidate routes, determine, according to the amount of energy supplemented for the vehicle at each of the backup energy stations on the any of the candidate routes and the node cost when the vehicle reaches each of the backup energy stations, an energy cost on the any of the candidate routes, and plan the travel route for the vehicle according to the energy cost on each of the candidate routes and the amount of energy supplemented for the vehicle at each of the backup energy stations on each of the candidate routes.
